(19) United States
(12) Patent Application Publication
(10) Pub. No.: US 2008/0086225 A1
(43) Pub. Date: Apr. 10, 2008

(54) Audio converting and playing device

(75) Inventor: Fong-Fu Lin, Taiping City (TW)

Correspondence Address: PATENTTM.US, P. O. BOX 82788, PORTLAND, OR, 97282-0788, US

(73) Assignee: JUSTER CO., LTD.

(21) Appl. No.: 11/350,054

(22) Filed: Feb. 7, 2006

(51) Int. Cl. G06F 17/00

(52) U.S. Cl. 700/94

(57) ABSTRACT

An audio converting and playing device includes a power amplifier host and a converter. The power amplifier host includes a body coupled to an amplifier speaker. Both sides of the body respectively form a sliding groove. Multiple signal input connectors are mounted on the body. The converter forms an open container integrally formed on an U-shaped holder. Two ribs are formed respectively at internal sides of the U-shaped holder to be held in the sliding groove correspondingly. Signal connection ports are mounted on a bottom of the container. Signal output connectors are mounted on an external surface of the container. The signal output connectors can output audio to an external microphone device by an appropriate specification signal line.

### BACKGROUND OF THE INVENTION

1. Field of the Invention

The invention relates in general to an audio converting and playing device, and more particularly to an audio converting and playing device that can be coupled to different audio devices to output digital audio data stored in the audio devices.

2. Description of the Related Art

Various portable electronic devices such as MP3, MP4 player, iPod™, PDA, new model mobile phone or 3G mobile phone that can be used to watch television programs are very popular. Most of these electronic devices have audio signal output functions allowing the devices to be directly connected to a headphone or a mini audio player. A mini sound box is also brought to the market, which can be coupled with some electronic devices to play digital audio files. However, these expanded accessories for audio output devices are usually only designed for single type of the signal audio device respectively, which are not suitable to different audio devices. When a user has various electronic devices, the conventional audio output devices are not compatible to all of the electronic devices. Hence the conventional audio output devices can be further improved.

### SUMMARY OF THE INVENTION

An objective of the present invention is to provide an audio converting and playing device that can be coupled to different kinds of audio devices to output audio data stored in the audio devices.

In order to achieve the above objective, the device includes a power amplifier host and a converter.

The power amplifier host includes a body coupled to an amplifier speaker. Both sides of the body respectively form a sliding groove. Multiple signal input connectors are mounted on a back side surface of the body.

The converter forms an open container on a U-shaped holder. Two ribs are formed respectively at two opposite internal sides of the U-shaped holder that can be held in the sliding groove correspondingly. Multiple signal connection ports are formed on a bottom in the open container. Multiple signal output connectors are configured on an external surface the open container.

The signal connection ports include a digital signal I/O terminal, an analog signal terminal, a power source terminal, an USB connection port and the like. The signal output connectors are electrically connected to the signal connection ports on the bottom in the container through a circuit board in the container. The signal output connectors can output audio to an external microphone device by an appropriate specification signal line.

The signal connection ports formed on the bottom in the open container can be correspondingly coupled to an optional adapter. The adapter can be coupled to an external audio device.

Furthermore, a clip board is assembled on the bottom of the open container, so as to be able to fix a light and compact audio device.

### BRIEF DESCRIPTION OF THE DRAWINGS

FIG. 1 is a perspective view of an audio converting and playing device in accordance with one embodiment of the present invention.

FIG. 2 is a back view of the embodiment of FIG. 1.

FIG. 3 is an exploded perspective view of an audio converting and displaying device in accordance with a second embodiment of the present invention.

FIG. 4 is a top view diagram of the audio converting and displaying device of FIG. 3.

FIG. 5 is an exploded perspective view of an audio converting and displaying device in accordance with a third embodiment of the present invention.

FIG. 6 is a circuit diagram of a converter in accordance with the present invention.

FIGS. 7A-7D show a circuit diagram of a power amplifier host in accordance with the present invention.

### DETAILED DESCRIPTION OF THE INVENTION

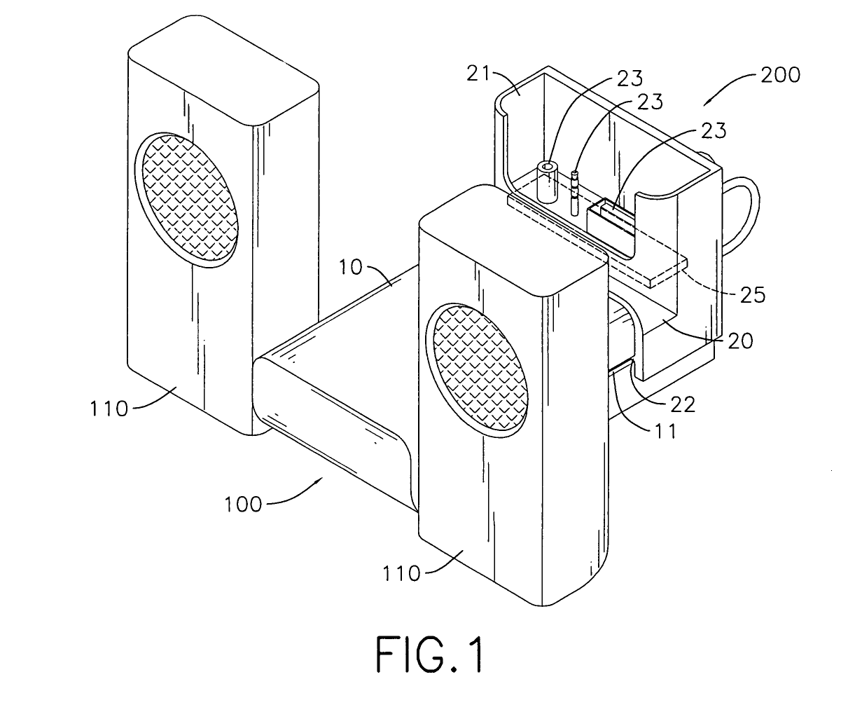

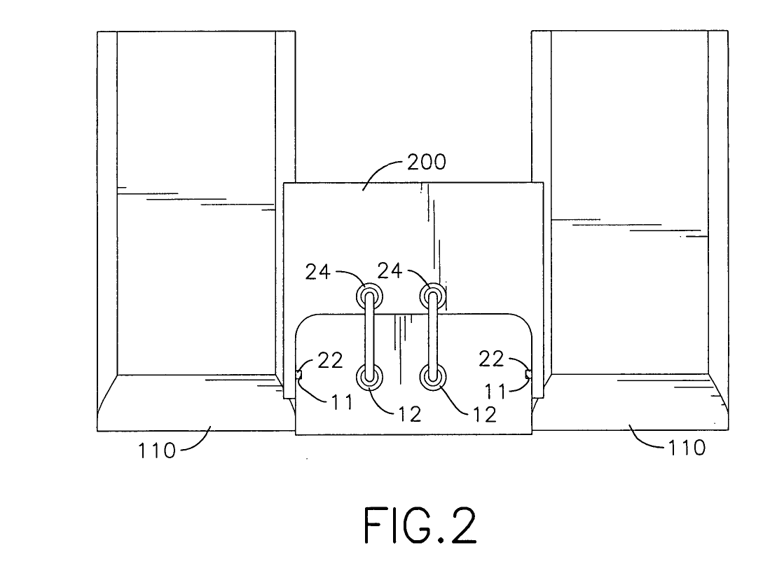

With reference to FIG. 1 and FIG. 2, an audio converting and playing device of a first embodiment of the present invention includes a power amplifier host 100 and a converter 200. The power amplifier host 100 includes a rectangular body 10 with a lengthwise sliding groove 11 at both sides of the body 10. Two amplifier speakers 110 are pivotally connected at the two sides of the body 10, respectively. The amplifier speakers 110 output sound signals processed by the power amplifier host 100. Multiple signal input connectors 12 are mounted on a back side surface of the body 10, so that an appropriate specification signal line can make the converter 200 coupled to the signal input connectors 12. The converter 200 forms an open container 21 on an U-shaped holder 20. Two ribs 22 are formed respectively at two opposite internal sides of the U-shaped holder 20. The two ribs 22 can be held in the two sliding grooves 11 on both sides of the body 10 to mount the converter 200 on the power amplifier host 100. A first mounting manner is to push the converter 200 moving forward from a back of the power amplifier host 100 to make the ribs 22 slide along the sling grooves 11. When the ribs 22 are fully put in the sling groove 11, the converter 200 is completely attached to the body 10.

A second mounting manner is to press the converter 200 from the top toward the body 10. Since the U-shaped holder 20 is made by plastic material, when the U-shaped holder 20 is placed on the body 10 and pressed downward, the U-shaped holder 20 are slightly spread to mount on both sides of the body 10. When the U-shaped holder 20 is pressed continuously, the ribs 22 can be direct stuck inside the sliding grooves 11. When the converter 200 is assembled on the body 10, the converter 200 also can slide back and forth in opposition to the body 10.

Multiple different signal connection ports 23 are formed on a bottom in the open container 21. The signal connection ports 23 include a digital signal I/O terminal, an analog signal terminal, a power source terminal, an USB connection port and the like. In this preferred embodiment, the analog signal terminal is a signal plug. Moreover, signal output connectors 24 are configured on a back of the container 21. The signal output connectors 24 are electrically connected to the signal connection ports 23 on the bottom in the container 21 through a circuit board 25 in the container 21. The signal output connectors 24 can output audio to an external microphone device by an appropriate wire (not numbered). For example, in this preferred embodiment, the signal input connectors 12 on the back of the body 10 of the power amplifier host 100 can be correspondingly connected with the signal output connectors 24.

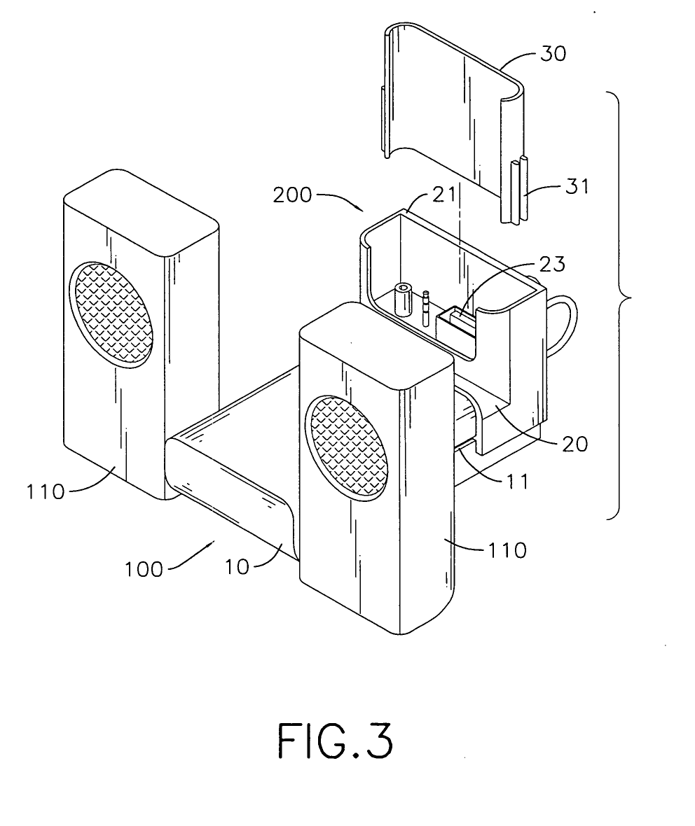

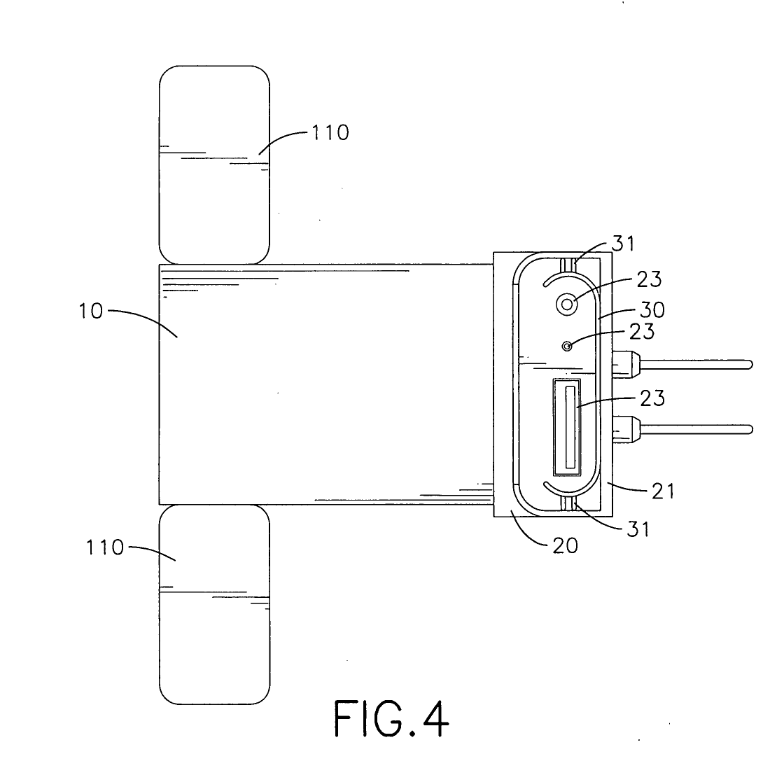

With reference to FIG. 3 and FIG. 4, the container 21 of a second embodiment of the present invention further comprises an optional clip board 30. Both sides of the clip board 30 bend forward slightly forming a U shape with two ribs 31 formed at each external side. When the clip board 30 is assembled in the container 21, the ribs 31 lean against an internal side surface of the container 21, so that the clip board 30 can be firmly mounted in the container 21. Since different external audio device such as a mobile phone, iPod, PDA has different size; an original internal width of the container 21 may be too large for some light and compact audio devices. Hence the light and compact audio devices may not be firmly held in the container 2 1. In order to avoid the situation, the clip board 30 should be assembled inside the container 21 first to minimize the space inside of container 21.

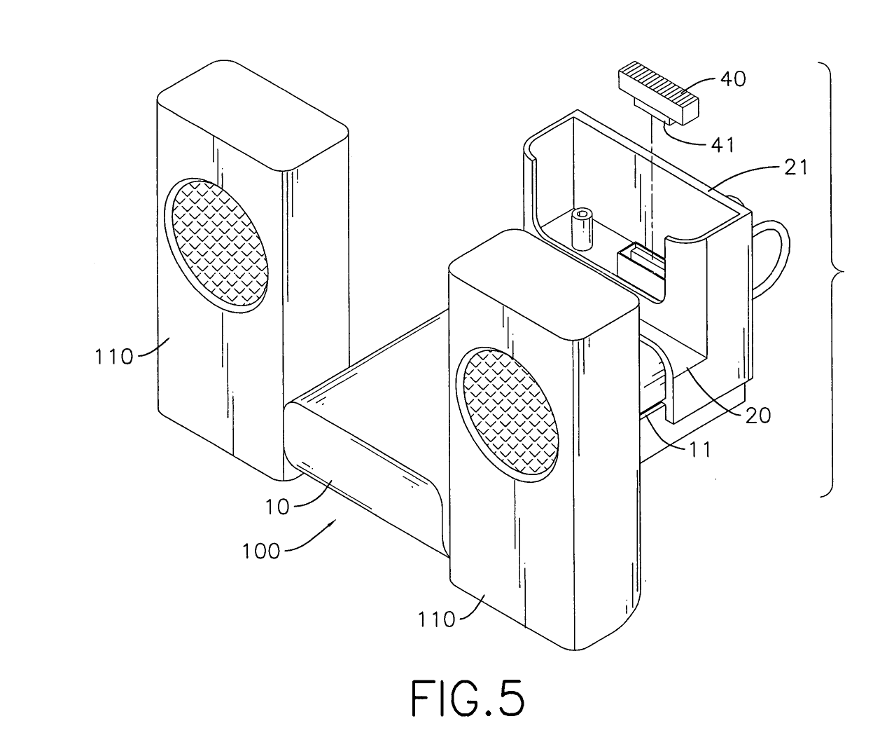

With reference to FIG. 5, a third embodiment of the present invention illustrates that the signal connection ports 23 on the bottom of the container 21 of are expandable and changeable. An optional adapter 40 can be applied in this preferred embodiment. A bottom of the adapter 40 can be an USB connection terminal 41 corresponding to the USB connection port of the signal connection ports 23, or also can be a digital I/O connector. A top of the adapter 40 varies depending on the signal output ports of different external audio device. Hence the present invention can be compatible for different audio device to expand functions by adding the adapter 40.

In practical application, an external audio device is held inside the container 21 and electrically connected to the signal connection ports 23. Audio data stored in the audio device can be processed and amplified by the converter 200 and the power amplifier host 100, and then played by the amplifier speakers 110.

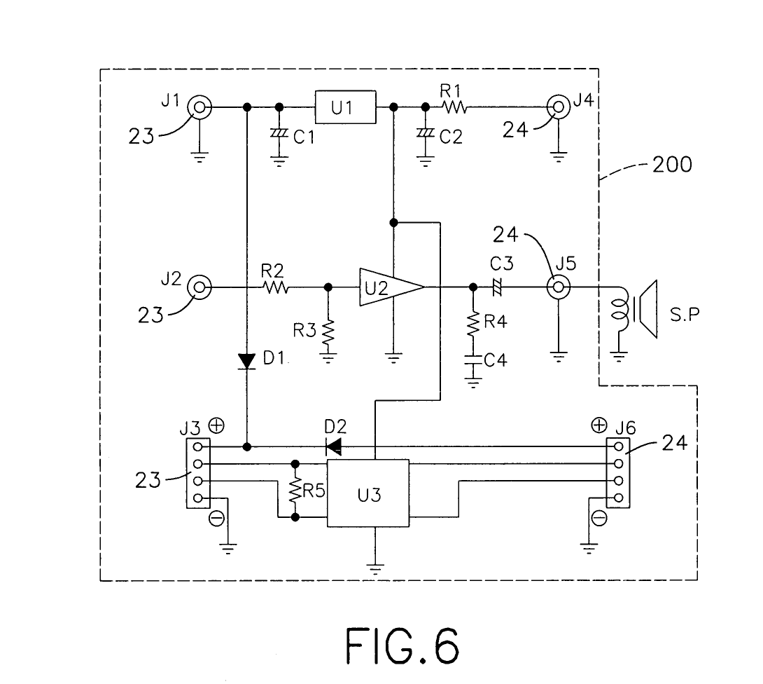

With reference to FIG. 6, a circuit block diagram of the converter 200 comprises J1, J2 and J3 that indicate the signal connection ports 23 on the bottom of the container 21. J4, J5 and J6 indicate the output connectors 24 on the back of the container 21. The J1 and J2 are analog signal inputs, and J3 is a digital signal input. The J4 and J5 are the analog signal input, and J6 is a digital signal input. The J1 and J4 are used as power source terminals and J4 can provide a direct current voltage by a power regulation IC U1 and a filter capacitor C2.

The analog signal input J2 is coupled to an impedance match circuit made up by two resistors R2 and R3. The impedance match circuit is further coupled to an input terminal of a power amplifier U2. The power amplifier U2 can amplify signals and improve tone quality. An output terminal of the power amplifier U2 is coupled to resistor R4 and capacitor C4 both connected in series to avoid audio frequency parasitic oscillation. The output terminal of the power amplifier U2 is further coupled to an output audio frequency coupling capacitor C3. The other terminal of the audio frequency coupling capacitor C3 is coupled to an output terminal of J5. The analog signal output terminal J5 can provide to couple to an external microphone device.

The digital signal input terminal J3 includes positive and negative input pins of DC (direct current) voltage and signal input pins. The DC voltage can be obtained through the power source terminal J1 coupling to a forward diode.

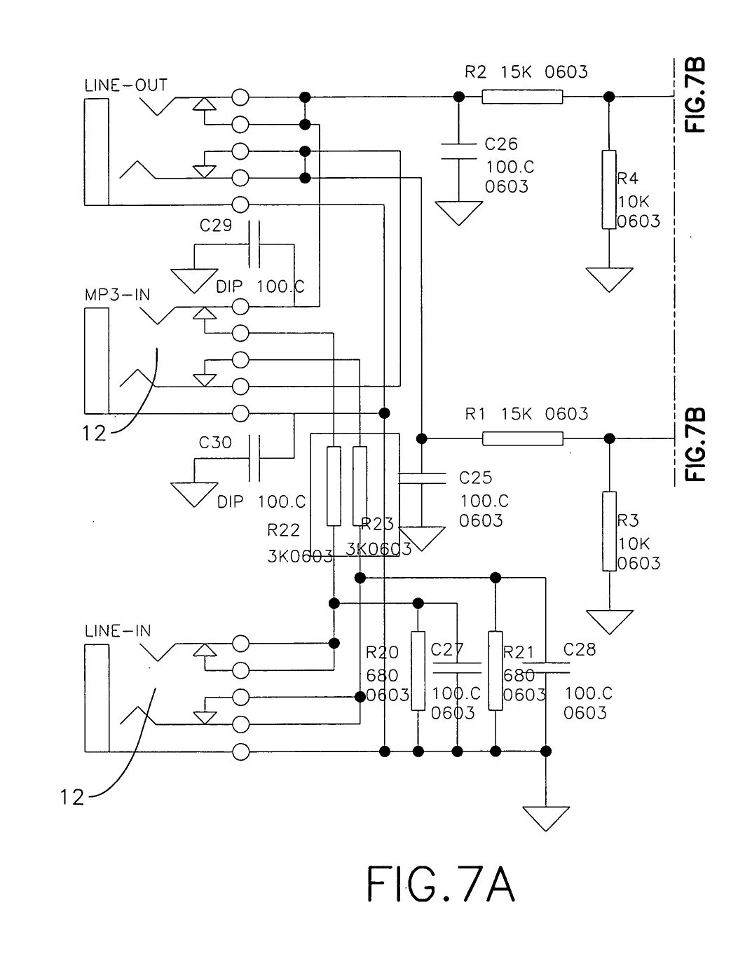

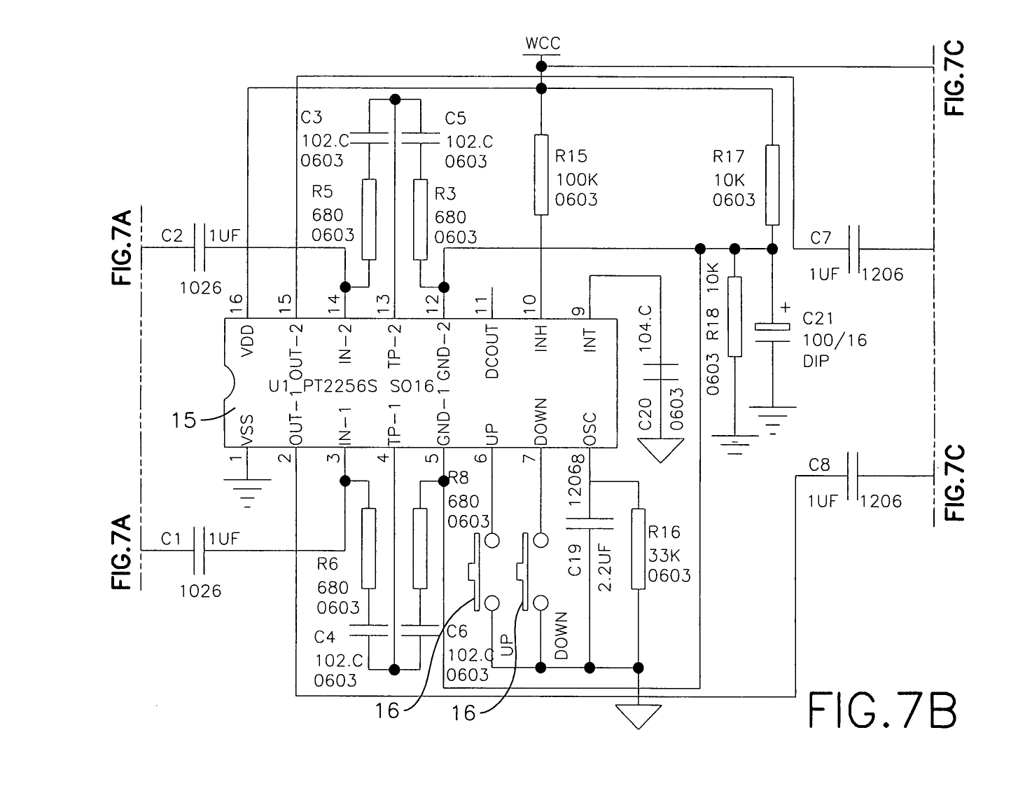

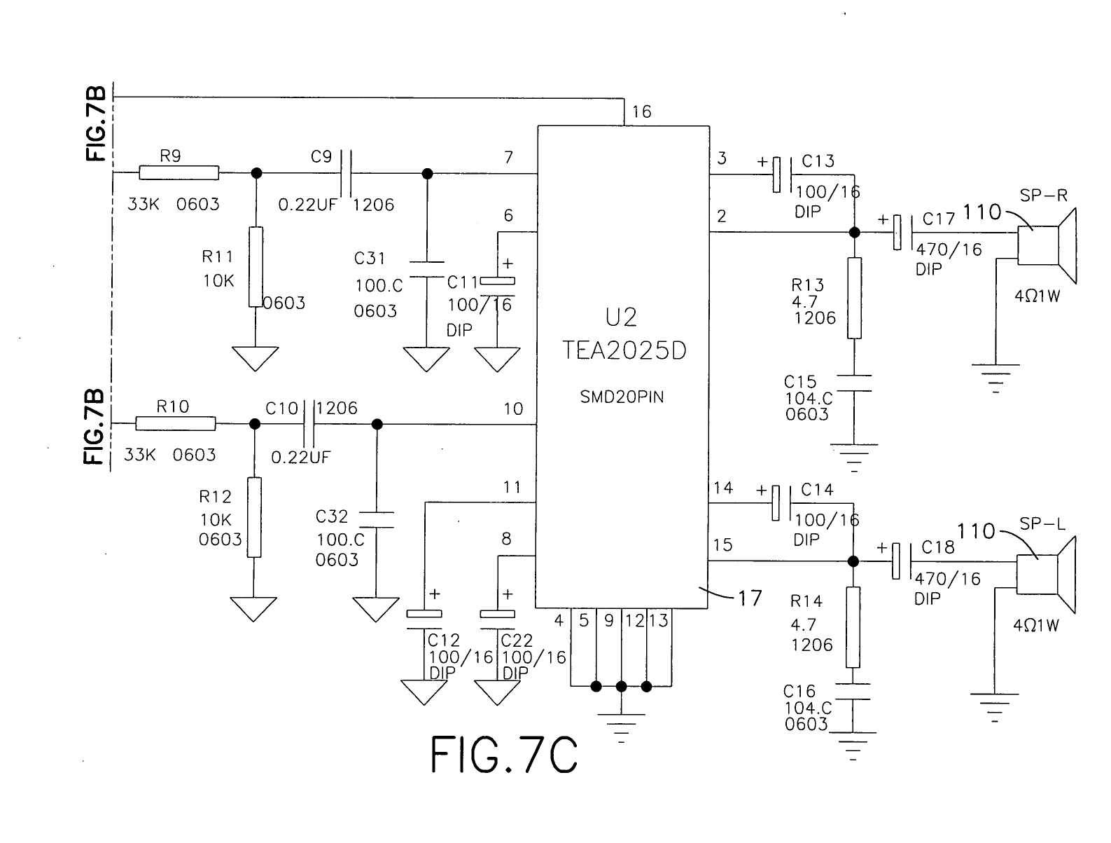

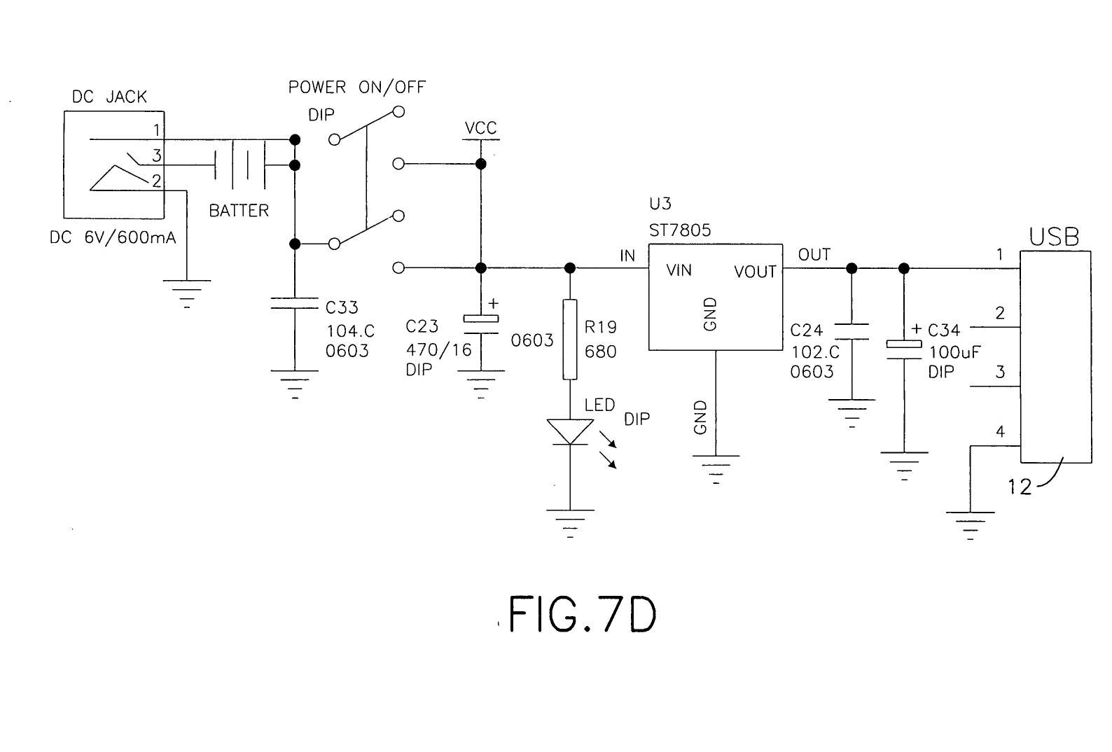

With reference to FIGS. 7A-7D, a detailed circuit diagram of the power amplifier host 100 is shown. The signal input connectors 12 include an USB connector, an analog signal line-in port and a digital signal input port to receive digital audio files such as MP3. The analog signal line-in port and the digital signal input port receive signals and then send to a pre-amplifier unit 15. The pre-amplifier unit 15 is coupled to two volume control buttons 16 to be louder or lower down. The signals processed by the pre-amplifier unit 15 are then outputted to a post-amplifier unit 17. Two output terminals of the post-amplifier unit 17 are respectively coupled to the amplifier speakers 110.

To conclude, the audio converting and playing device of the present invention can couple to different specification external audio devices by the adapter. Therefore the audio converting and playing device can be compatible for various portable electronic devices and extract the audio data stored in the electronic devices to play, which is obviously improved and advanced in comparison with the conventional audio playing device that can only support single electronic device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio converting and playing device comprising:
a power amplifier host comprising a body coupled to an amplifier speaker, the body having multiple different signal input connectors and having two sides on which two sliding grooves are respectively defined;
a converter comprising an open container formed on an U-shaped holder, the U-shaped holder having two internal opposite walls with ribs to be held in the sliding groove correspondingly, the opening container having multiple different signal connection ports mounted on a bottom of the open container, and having multiple signal output connectors on an external surface of the open container.

2. The device as claimed in claim 1, wherein at least one of the signal connection port on the bottom of the open container is correspondingly coupled to an adapter.

3. The device as claimed in claim 1, wherein a clip board is held inside the open container.

4. The device as claimed in claim 2, wherein a clip board is held inside the open container.

5. The device as claimed in claim 3, wherein the signal connection ports on the bottom of the container include a digital signal I/O terminal, an analog signal terminal, a power source terminal, and an USB connection port.

6. The device as claimed in claim 4, wherein the signal connection ports on the bottom of the container include a digital signal I/O terminal, an analog signal terminal, a power source terminal, and an USB connection port.

7. The device as claimed in claim 5, wherein the clip board is bent to form a U shape with two ribs formed at two external sides of the clip board.

8. The device as claimed in claim 6, wherein the clip board is bent to form a U shape with two ribs formed at two external sides of the clip board.

9. The device as claimed in claim 7, wherein a bottom of the adapter is an USB connection terminal and a top of the adapter is corresponding to a signal output port of an external audio device.

10. The device as claimed in claim 8, wherein a bottom of the adapter is an USB connection terminal and a top of the adapter is corresponding to a signal output port of an external audio device.

11. The device as claimed in claim 7, wherein a bottom of the adapter is a digital I/O connector and a top of the adapter is corresponding to a signal output port of an external audio device.

12. The device as claimed in claim 8, wherein a bottom of the adapter is a digital I/O connector and a top of the adapter is corresponding to a signal output port of an external audio device.

13. The device as claimed in claim 7, wherein the signal input connectors are mounted at a back side of the body, and the signal output connectors are mounted at a back side of the container.

14. The device as claimed in claim 8, wherein the signal input connectors are mounted at a back side of the body, and the signal output connectors are configured at a back side of the container.

15. The device as claimed in claim 7, wherein the signal input connectors of the power amplifier host is coupled to a pre-amplifier unit, wherein signals processed by the pre-amplifier unit are outputted to the amplifier speaker through a post-amplifier unit.

16. The device as claimed in claim 8, wherein the signal input connectors of the power amplifier host is coupled to a pre-amplifier unit, wherein signals processed by the pre-amplifier unit are outputted to the amplifier speaker through a post-amplifier unit.
